(19) United States
(12) Patent Application Publication
(10) Pub. No.: US 2025/0019514 A1
(43) Pub. Date: Jan. 16, 2025

(54) PROCESS FOR HYDROLYSIS OF (POLY)CARBONATES

(71) Applicant: COVESTRO DEUTSCHLAND AG, Leverkusen (DE)

(72) Inventors: Matthias Leven, Köln (DE); Norah Heinz, Leverkusen (DE); Jens Langanke, Mechernich (DE); Torsten Heinemann, Leichlingen (DE); Kai Laemmerhold, Odenthal (DE); Martin Tabak, Aachen (DE); Tugrul Nalbantoglu, Aachen (DE); Walter Leitner, Aachen (DE)

(21) Appl. No.: 18/704,815

(22) PCT Filed: Oct. 20, 2022
(86) PCT No.: PCT/EP2022/079205

§ 371 Date: Apr. 25, 2024

(30) Foreign Application Priority Data
Oct. 29, 2021 (EP) 21205595.8

(51) Int. Cl. C08J 11/14; C08J 11/28

(52) U.S. Cl. CPC C08J 11/14; C08J 11/28; C08J 2369/00

(57) ABSTRACT

The present invention relates to a process for hydrolysis of carbonates, in particular polycarbonates, in the presence of at least one phase-transfer catalyst. The process according to the invention makes it possible to recover valuable raw materials from industrially produced carbonates, in particular polycarbonates, once these have fulfilled their original intended purpose. It thus avoids a loss of such raw materials, such as would arise in the event of disposal by incineration or landfill for instance.

### CROSS REFERENCE TO RELATED APPLICATIONS

This application is a U.S. national stage application, filed under 35 U.S.C. § 371, of International Application No. PCT/EP2022/079205, which was filed on Oct. 20, 2022, and which claims priority to European Patent Application No. 21205595.8, which was filed on Oct. 29, 2021. The entire contents of each are hereby incorporated by reference into this specification.

The present invention relates to a process for hydrolysis of carbonates, in particular polycarbonates, in the presence of at least one phase-transfer catalyst. The process according to the invention makes it possible to recover valuable raw materials from industrially produced carbonates, in particular polycarbonates, once these have fulfilled their original intended purpose. It thus avoids a loss of such raw materials, such as would arise in the event of disposal by incineration or landfill for instance.

### BACKGROUND

Carbonates are versatile products. Polycarbonates in particular enjoy a variety of applications in industry and in everyday life. They are known for their good profile of properties having regard to mechanical and optical properties, heat resistance and weathering stability. This profile of properties has the result that polycarbonates are used in a very wide variety of interior and exterior applications. Due to this range of possible applications and associated economic success large amounts of polycarbonate wastes are also generated (for example from old housings, lamp coverings, compact discs etc.). Such polycarbonate waste must be sent to a sensible use. The use that is easiest to implement technically is that of incineration to utilize the liberated heat of combustion for other processes, for example industrial processes. However, this does not make it possible to close the raw materials loops. Another type of use is so-called “physical recycling”, which sees polycarbonate wastes mechanically comminuted and used in the production of new products. This type of recycling naturally has its limits and there has therefore been no lack of attempts to recover the basic raw materials of polycarbonate production by retrocleavage of the polycarbonate bonds (so-called “chemical recycling”). The raw materials to be recovered generally comprise bisphenols, in particular bisphenol A. Depending on the type of chemical recycling it may also afford a carbonate-containing compound such as diphenyl carbonate or dimethyl carbonate or else CO₂.

### SUMMARY

The present invention relates to the hydrolysis of carbonates, in particular polycarbonates. This generally affords an alcohol or diol (depending on the type of starting compound to be cleaved) and CO₂. The term hydrolysis is known to those skilled in the art. According to the invention the term “hydrolysis” is especially to be understood as describing the cleavage of a carbonate group by water. In the “hydrolysis of polycarbonates” generally a plurality of carbonate groups, preferably virtually all carbonate groups, in the polymer chain are cleaved by water. This generally does not preclude further solvents, for example alcohols, from being present during the hydrolysis. In this case it is also possible that the presence of at least one alcohol initially results intermediately in at least partial formation of esters (in some cases the carbonate groups are directly cleaved by the water). However, these esters should be re-cleaved by water under the conditions according to the invention. Thus in this case too cleavage by water is effected (albeit not directly of the carbonate groups but rather of an intermediately formed ester group). This cleavage of the intermediate ester group is preferably likewise encompassed by the term “hydrolysis”. In another embodiment this cleavage of the intermediate ester group is not encompassed by the term “hydrolysis” according to the invention. With preference according to the invention at least one organic solvent may be present in the hydrolysis. Said solvent may be supplied simultaneously with the water and/or subsequently to the water of the hydrolysis. It is preferable when this at least one organic solvent is selected from the group consisting of acetone, acetophenone, cyclohexanone, cyclopentanone, methyl ethyl ketone, methyl benzoate, cyclopropylene carbonate, cycloethylene carbonate, ethyl acetate, γ-butyrolactone, acetonitrile, tert-butyl methyl ether, chlorobenzene, o-dichlorobenzene, dichloromethane, chloroform, dibutyl ether, dimethylformamide, dimethyl sulfoxide, 1,4-dioxane, ethylene glycol dimethyl ether, methylene chloride, N-methyl-2-pyrrolidone, nitromethane, phenol, sulfolane, tetrahydrofuran, toluene and at least one alcohol. It is also possible to use any desired mixtures. It is likewise preferable when none of these organic solvents are present during the hydrolysis. It is especially preferable when at least one alcohol is present during the hydrolysis. It will be appreciated that said alcohol is distinct from the hydrolysis product. In this case it is further preferable when the at least one alcohol is selected from the group consisting of methanol, ethanol, propanol, isopropanol, propane-1,3-diol, n-butanol, 2-butanol, isobutanol, tert-butanol, butane-1,4-diol, n-pentanol, 2-pentanol, 3-pentanol, isoamyl alcohol, 2-methyl-2-butanol, neopentanol, 2-methyl-1-butanol, 3-methyl-2-butanol, pentaerythritol, cyclopentanol, hexane-1-ol, hexane-2-ol, hexane-3-ol, 2-methylpentane-1-ol, 2-methylpentane-2-ol, 2-methylpentane-3-ol, 4-methylpentane-1-ol, 4-methylpentane-2-ol, 3-methylpentane-1-ol, 3-methylpentane-2-ol, 3-methylpentane-3-ol, 2,2-dimethylbutane-1-ol, 3,3-dimethylbutane-1-ol, 3,3-dimethylbutane-2-ol, 2,3-dimethylbutane-1-ol, 2,3-dimethylbutane-2-ol, 2-ethylbutane-1-ol, 4-methylpentane-2-ol, cyclohexanol, phenol and 2-ethylhexanol. Any mixture of these alcohols may also be used. It is very particularly preferable when in addition to the at least one alcohol no further organic solvent, in particular none of the organic solvents indicated as preferred hereinabove, is present in the hydrolysis of process step (ii) according to the invention. Thus the only organic solvent present in process step (ii) is the at least one alcohol, preferably at least one alcohol selected from the group consisting of methanol, ethanol, propanol, isopropanol, propane-1,3-diol, n-butanol, 2-butanol, isobutanol, tert-butanol, butane-1,4-diol, n-pentanol, 2-pentanol, 3-pentanol, isoamyl alcohol, 2-methyl-2-butanol, neopentanol, 2-methyl-1-butanol, 3-methyl-2-butanol, pentaerythritol, cyclopentanol, hexane-1-ol, hexane-2-ol, hexane-3-ol, 2-methylpentane-1-ol, 2-methylpentane-2-ol, 2-methylpentane-3-ol, 4-methylpentane-1-ol, 4-methylpentane-2-ol, 3-methylpentane-1-ol, 3-methylpentane-2-ol, 3-methylpentane-3-ol, 2,2-dimethylbutane-1-ol, 3,3-dimethylbutane-1-ol, 3,3-dimethylbutane-2-ol, 2,3-dimethylbutane-1-ol, 2,3-dimethylbutane-2-ol, 2-ethylbutane-1-ol, 4-methylpentane-2-ol, cyclohexanol, phenol and 2-ethylhexanol. As those skilled in the art will be aware it goes without saying that traces of organic solvents introduced via the reactants in process step (ii) may be present.

It is especially preferable when the employed amount of the at least one organic solvent, in particular of the at least one alcohol, is not excessively high relative to the water. It is particularly preferable when the mass of the at least one organic solvent, in particular of the at least one alcohol, is at most 15%, particularly preferably 0% to 10%, especially preferably 1% to 7% and very particularly preferably 0% to 4% of the mass of the water. It is especially preferable when the above-described organic solvents, in particular alcohols, are used. In a particularly preferred embodiment the total mass of an organic solvent, in particular alcohol, during the hydrolysis is at most 4%, especially preferably at most 3%, more preferably at most 2% and very particularly preferably at most 1% of the mass of the water.

Green Chem., 2005, 7, 380-387 describes the alcoholysis (partly also to be understood as hydrolysis according to the preferred term of the invention) of polycarbonate wastes especially with a mixture of methanol and water and NaOH as catalyst. The co-use of water is portrayed as disadvantageous since compared to the use of pure methanol the mixture results in a reduced selectivity and lower yields with simultaneous loss of dimethyl carbonate as a byproduct. It was additionally observed that the more water was used, the longer the required reaction time.

Green Chem 2007, 9, 38-43 describes the glycolysis of polycarbonate using sodium carbonate as catalyst. The resulting bishydroxyalkyl ethers may be used as new starting products for production of polyurethanes. However, they are generally not starting products for renewed production of polycarbonates.

Catalysis Communications 84 (2016) 93-97 describes the complete hydrolysis of polycarbonate with CeO₂ as catalyst under hydrothermal conditions. Polycarbonate was not able to be cleaved using water alone in a pressure tube at 200° C. Depolymerization was only achieved upon addition of the catalyst. However, the conditions described here are very harsh. This is ecologically and economically disadvantageous.

Example 7 of CN101407450 A describes the depolymerization of polycarbonate in an autoclave at 120° C. in a mixture of water and tetrahydrofuran and KOH as catalyst. Here too, the described conditions for cleavage of the carbonate group are ecologically and economically optimizable.

In Journal of Hazardous Materials vol. 241-242, 2021 Sep. 23, pages 137-145 Tsintzou et al. describe a process for alkaline hydrolysis of BPA-based polycarbonate by phase-transfer catalysis under microwave irradiation. The process conditions described therein are relatively harsh. Temperatures of 160° C. are described for instance. For large industrial scale processes such harsh conditions are ecologically and economically rather undesirable. This document also teaches the use of superstoichiometric amounts of alkali metal hydroxide solution. This forms large amounts of contaminated alkali metal salts which would require disposal in the corresponding industrial context of the process.

WO2020/257237A1 describes a process for hydrolysis of polycarbonate, where sodium carbonate is employed as a hydrolysis catalyst. This document too describes temperatures of 120° C. to obtain high depolymerization yields.

In Journal of Molecular Catalysis A: Chemical vol. 426, pages 107-116 Iannone et al. describe the use of ionic liquids and ZnO nanoparticles as catalysts for the depolymerization of polycarbonate. Bu₄NCl is inter alia employed to stabilize the metal nanoparticles and prevent aggregation which is said to increase catalyst service life.

Only very few of the processes of chemical recycling known from the literature are currently operated on a large industrial scale. This is mainly due to the reaction conditions which compare poorly in terms of economics to the use of new, non-recycled starting products. In view of generally increased environmental awareness and increased efforts to configure industrial processes to be as sustainable as possible—both of which fundamentally favour chemical recycling—this appears to show that the chemical recycling of carbonates, especially of polycarbonate products, is still by no means mature from a technical and economic point of view. Challenges exist for example with respect to the efficiency of catalytic carbonate cleavage. Conventional process approaches which require high temperatures always harbour the risk of discoloration, formation of byproducts etc. This likewise has the result that the recycling of recovered raw materials is considerably impeded or rendered uneconomic.

There is therefore a need for further improvements in the field of chemical recycling of carbonates, in particular of polycarbonates and/or polycarbonate products. It would especially be desirable to provide a process in which hydrolysis is efficiently catalysed and which can therefore preferably be performed at relatively low temperature. There was therefore also a need to provide a process, in particular a hydrolysis, which allows cleavage of carbonates, in particular polycarbonates, on a large industrial scale. The workup of the reaction products should preferably be simple.

At least one of the recited objects, preferably all of these objects, have been achieved by the present invention. It has surprisingly been found that the presence of at least one phase-transfer catalyst results in a high conversion in the hydrolysis of carbonates, in particular of polycarbonates, under relatively mild conditions. This is especially to be understood as meaning that the presence of at least one phase-transfer catalyst in the hydrolysis results in a high yield of hydrolysis products. This allows relatively mild conditions to be employed, with the result that the process according to the invention is particularly suitable for a large industrial scale process. The process according to the invention is accordingly an ecologically and/or economically advantageous process. It was likewise found that the hydrolysis products were able to be worked up particularly readily. This is especially the case when the amount of organic solvent in the system is limited.

The present invention provides a process for hydrolysis of carbonates, preferably of polycarbonates, comprising the steps of:
(i) providing a carbonate, at least one hydrolysis catalyst and water, wherein the at least one hydrolysis catalyst comprises a salt of an oxyacid of an element of the fifth, sixth, fourteenth or fifteenth group of the periodic table of the elements, wherein the pK_{B} value of the anion of the salt is in the range from 0.1 to 7.0 and
(ii) performing the hydrolysis by contacting the components from step (i) to obtain at least one hydrolysis product and carbon dioxide,
   wherein the process according to the invention is characterized in that in step (ii) at least one phase-transfer catalyst is present, wherein the at least one phase-transfer catalyst comprises a charged organic molecule.

### DETAILED DESCRIPTION

The term “carbonate” in the context of the present invention represents a chemical compound which comprises one, at least one or more carbonate group(s). A carbonate group is to be understood as meaning the functional group R—O—(C═O)—O—R, wherein the two radicals R may in each case be identical or different. The term particularly preferably represents a chemical compound comprising at least one carbonate group. However, to elucidate the different reaction products a distinction is often made between a carbonate and a polycarbonate although according to the invention a carbonate may readily also be a polycarbonate. A carbonate very particularly preferably comprises only one carbonate group.

The term “polycarbonate” in the context of the present invention refers to a polymer having a plurality of carbonate groups. The carbonate groups are present in the polymer backbone. This is to be understood as meaning that a polycarbonate preferably comprises repeating units of the type . . . —(R—O—(C═O)—O—)— . . . . The term polycarbonate is to be understood as meaning both homopolycarbonates and copolycarbonates. The polycarbonates may be linear or branched in the familiar manner. A person skilled in the art is likewise aware that polycarbonate products in particular also employ mixtures of different polycarbonates. The term polycarbonate therefore also encompasses any desired mixtures of such polycarbonates. The polycarbonates may especially also include so-called post-consumer polycarbonate. This term is familiar to those skilled in the art. It especially relates to moulded polycarbonate parts made of polycarbonate compositions which have already been used for their intended purpose and are now to be sent for disposal. The polycarbonate compositions may contain corresponding relevant additives and blend partners. It may be necessary to separate these from the actual polycarbonate by known processes before performing the process according to the invention.

The “water” employed in process step (i) is preferably employed in superstoichiometric amounts. This is to be understood as meaning that the water is employed in an amount that is theoretically sufficient to hydrolyse all of the carbonate bonds of the (poly)carbonate to afford a hydrolysis product with liberation of carbon dioxide. The water is preferably freed of oxygen by inert gas saturation (for example with nitrogen, argon and/or helium). The water used may in principle be any optically clear water, for example filtered river water or well water. Preference is given to using demineralized water. In general, the demineralized water used exhibits conductivities of less than 20 μS/cm, preferably less than 12 μS/cm, this being determined according to DIN EN 27888 in conjunction with DIN 50930-6.

The term “hydrolysis catalyst” is known to those skilled in the art. Such a hydrolysis catalyst is in particular capable of reducing the activation energy of the hydrolysis of the carbonate and in particular of the polycarbonate (compared to the activation energy of the hydrolysis of the carbonate without an additional catalytically active compound). The hydrolysis catalyst is thus preferably capable of effecting addition of water onto the carbonyl function of the carbonate ester. In some cases the hydrolysis catalyst may also be identical to the phase-transfer catalyst according to the invention. The present invention also encompasses embodiments in which in addition to the hydrolysis activity a hydrolysis catalyst also has a certain activity as a phase-transfer catalyst. The activity/the magnitude of the activity is determinable via the absolute amount by which it reduces the activation energy for the hydrolysis. In the case of an additional activity as a phase-transfer catalyst the hydrolysis catalyst additionally has the capacity to more easily overcome the phase interface itself (regarding the magnitude of the activity of a phase interface catalyst see below). However, in this case the catalyst is preferably subsumed under the term hydrolysis catalyst since this is where its main activity lies. It is likewise possible to employ mixtures of different hydrolysis catalysts. Some or only one of the catalysts from this mixture can additionally have lesser or equally good phase-transfer catalysis properties. However, the process according to the invention preferably employs at least one hydrolysis catalyst and simultaneously at least one phase-transfer catalyst. However, the at least one catalyst may also have a certain activity as the other catalyst.

The term “phase-transfer catalyst” is known to those skilled in the art. Phase-transfer catalysts are especially substances which allow passage of a reactant into a chemical reaction through an interface of two immiscible phases into the phase in which a chemical reaction occurs. The transferred reactant then exhibits an elevated reactivity for the intended reaction especially on account of the altered solubility compared to a situation without the phase-transfer catalyst, the elevated concentration and the greater proximity to the other reactant(s). Without such a phase-transfer catalyst the intended reaction generally occurs only slowly, if at all. This also makes it possible to measure the magnitude of the activity of a phase-transfer catalyst. The activity and/or the magnitude of the activity of a phase-transfer catalyst is particularly preferably determinable by comparing the resulting yield of a reaction at identical time and identical temperature with and without a phase-transfer catalyst. A person skilled in the art generally employs the corresponding phase prisms here. According to the present invention the phase-transfer catalyst especially mediates the passage of the water to the carbonate, in particular polycarbonate, which is generally insoluble in the water. The phase-transfer catalyst simultaneously mediates the passage of the resulting hydrolysis product (alcohol or diol) into the surrounding water.

According to the invention the hydrolysis catalyst is a salt and the phase-transfer catalyst is a charged organic molecule. It has surprisingly been found that the use of charged catalysts allow the hydrolysis to be carried out at high yield under particularly mild process conditions. Without wishing to be bound to a particular theory it is thought that ion-pair formation (salt metathesis or the like) makes phase-transfer catalysis particularly efficient, thus making hydrolysis catalysis all the more efficient. This is particularly attributable to the fact that according to the invention the hydrolysis catalyst is at least partially chemically bonded to the phase-transfer catalyst, thus achieving particularly good solubility in the different phases of the reaction mixtures.

Process step (i) according to the invention comprises providing a carbonate, preferably a polycarbonate, at least one hydrolysis catalyst and water. This does not preclude the presence of other chemical substances in process step (i). Process step (i) may especially also comprise providing at least one organic solvent, in particular at least one alcohol. It is likewise preferable for at least one organic solvent, particularly preferably at least one alcohol, to be present in the hydrolysis of process step (ii). It is very particularly preferable when the organic solvent is at least one organic solvent selected from the group consisting of acetone, acetophenone, cyclohexanone, cyclopentanone, methyl ethyl ketone, methyl benzoate, cyclopropylene carbonate, cycloethylene carbonate, ethyl acetate, γ-butyrolactone, acetonitrile, tert-butyl methyl ether, chlorobenzene, o-dichlorobenzene, dichloromethane, chloroform, dibutyl ether, dimethylformamide, dimethyl sulfoxide, 1,4-dioxane, ethylene glycol dimethyl ether, methylene chloride, N-methyl-2-pyrrolidone, nitromethane, phenol, sulfolane, tetrahydrofuran, toluene and an alcohol. If an alcohol is present then this alcohol is preferably water-soluble. It is very particularly preferable when the at least one alcohol is an alcohol from the group of alcohols recited in the definition of the term “hydrolysis” according to the invention. It is likewise preferable when the at least one organic solvent, in particular the at least one alcohol, is also employed in the amounts recited there. As described above it is preferable according to the invention when at most 15%, particularly preferably 0% to 10/0, very particularly preferably 1% to 7% and likewise preferably 0% to 4% of the mass of the water present in process step (ii) is an organic solvent. In one embodiment the “organic solvent” preferably comprises no alcohols in this context. In another embodiment the “organic solvent” comprises alcohols, particularly preferably the abovementioned alcohols. It is very particularly preferable when the organic solvent is selected from the group consisting of acetone, acetophenone, cyclohexanone, cyclopentanone, methyl ethyl ketone, methyl benzoate, cyclopropylene carbonate, cycloethylene carbonate, ethyl acetate, γ-butyrolactone, acetonitrile, tert-butyl methyl ether, chlorobenzene, o-dichlorobenzene, dichloromethane, chloroform, dibutyl ether, dimethylformamide, dimethyl sulfoxide, 1,4-dioxane, ethylene glycol dimethyl ether, methylene chloride, N-methyl-2-pyrrolidone, nitromethane, phenol, sulfolane, tetrahydrofuran, toluene and at least one alcohol. It is likewise preferable when the organic solvent is selected from the group consisting of acetone, acetophenone, cyclohexanone, cyclopentanone, methyl ethyl ketone, methyl benzoate, cyclopropylene carbonate, cycloethylene carbonate, ethyl acetate, γ-butyrolactone, acetonitrile, tert-butyl methyl ether, chlorobenzene, o-dichlorobenzene, dichloromethane, chloroform, dibutyl ether, dimethylformamide, dimethyl sulfoxide, 1,4-dioxane, ethylene glycol dimethyl ether, methylene chloride, N-methyl-2-pyrrolidone, nitromethane, phenol, sulfolane, tetrahydrofuran and toluene. It is preferable when at most 15% of the mass of the water present in process step (ii) is an organic solvent but at least one alcohol is present in the hydrolysis of process step (ii). This is preferably to be understood as meaning that the hydrolysis may be carried out in the presence of an alcohol, optionally also in the presence of a further organic solvent, but the total mass of this alcohol and/or organic solvent is limited to at most 15%, particularly preferably 0% to 10%, very particularly preferably 1% to 7% and likewise preferably 0% to 4% of the mass of the water present in process step (ii). It has been found that the limited amount of organic solvent in process step (ii) according to the invention makes the workup of the resulting products easier. The phase-transfer catalyst may likewise already be provided in step (i).

Especially when the carbonate is a polycarbonate it has proven advantageous for this polycarbonate to be comminuted, preferably mechanically comminuted, beforehand. As is known to those skilled in the art this increases the surface area of this solid and thus the activity for the hydrolysis to be performed. This is especially also useful when post-consumer polycarbonate is concerned. Comminution may be effected by commonly used methods, such as pressure comminution, percussive comminution, friction comminution, cutting comminution and impact comminution. The carbonate/polycarbonate may especially be subjected to milling. Milling may especially also be performed using a cryomill. It is preferable when the polycarbonate is comminuted such that it has an average particle size of less than 1 mm, preferably less than 0.5 mm, particularly preferably less than 50 μm and very particularly preferably less than 10 μm.

In process step (ii) the components from step (i) are contacted optionally with addition of the at least one phase-transfer catalyst if this has not already been provided in step (i). This enables and thus performs the actual hydrolysis reaction. According to the invention process steps (i) and (ii) may optionally not be sharply separated from one another. Conversely, process steps (i) and (ii) may also be performed at different locations. It is thus conceivable for example that especially the carbonate, particularly preferably the comminuted polycarbonate, is filled into suitable transport vehicles, for example silo vehicles, for further transport to process step (ii). At the site of the hydrolysis (process step (ii)) the carbonate is then filled into the reaction device intended for the hydrolysis.

The contacting of the components from step (i) is preferably carried out with introduction of mixing energy. This may be carried out by methods known to those skilled in the art. It is known that increasing surface renewal influences the rate of hydrolysis.

The hydrolysis may be performed in any reactor known for such a purpose in the specialist field. Autoclaves, stirred tanks (stirred reactors) and tubular reactors are particularly suitable as hydrolysis reactors.

Hydrolysis is preferably performed in the absence of oxygen. This means that the reaction is performed in an inert gas atmosphere (especially in a nitrogen, argon or helium atmosphere). It is especially advantageous when the employed water is also freed of oxygen by inert gas saturation.

The process according to the invention is preferably characterized in that process step (ii) is performed at a temperature of 50° C. to 180° C., particularly preferably 70° C. to 130° C., very particularly preferably 80° C. to 115° C., optionally under reflux or in a closed system. The process according to the invention especially makes it possible to realize low temperatures, in particular lower temperatures than in the prior art, for the hydrolysis. This has ecological and economic advantages. This also has the result that fewer byproducts are formed. It is apparent to a person skilled in the art which optimal conditions should be selected during the reaction for the particular preferences: The water should not evaporate. It is conversely also possible to achieve higher temperatures when the process is operated in a closed system, for example an autoclave. However, the reaction does not have any particular pressure requirements; it may likewise be performed at ambient pressure or slightly reduced pressure (especially with a lower pressure limit of 200 mbar(abs.), preferably 900 mbar(abs.)) which facilitates the removal of carbon dioxide formed. An only slightly elevated pressure of especially up to 1.8 bar(abs.) is likewise possible.

The hydrolysis has generally terminated within a period of 1.0 h to 48 h, preferably 1.5 h to 24 h, particularly preferably 2.0 h to 20 h, very particularly preferably 2.5 h to 19.0 h and exceptionally preferably 3.0 h to 18.0 h, i.e. after a reaction time within this duration only very slight further reaction, if any, occurs.

The process according to the invention is likewise characterized in that the at least one hydrolysis catalyst comprises a salt of an oxyacid of an element of the fifth, sixth, fourteenth or fifteenth group of the periodic table of the elements, wherein the pK_{B} value of the anion of the salt is in the range from 0.1 to 11.0, preferably 0.25 to 10.80, particularly preferably 0.50 to 10.60. The process according to the invention is likewise preferably characterized in that the at least one hydrolysis catalyst comprises a salt of an oxyacid of an element of the fifth, sixth, fourteenth or fifteenth group of the periodic table of the elements, wherein the pK_{B} value of the anion of the salt is in the range from 0.1 to 7.0, preferably 0.25 to 6.95, particularly preferably 0.50 to 6.85. It has quite surprisingly been found that hydrolysis of the carbonate bond is possible using the recited anionic compounds having low to moderate pK_{B} values even on a catalytic scale without stoichiometric use thereof. As already described above the hydrolysis catalyst is capable of effecting addition of water onto the carbonyl function of the carbonate ester. The hydrolysis catalyst consists of at least one anion and at least one cation.

As regards the salt of an oxyacid of an element of the fifth, sixth, fourteenth or fifteenth group of the periodic table of elements (salt of oxyacid for short below), it is not necessary for the purposes of the present invention for the oxyacid per se to be a stable, isolable compound. Thus for example carbonates are formally derivable from “carbonic acid ‘H₂’”; the fact that this is not isolable in pure form is not an obstacle and does not depart from the scope of the present invention.

pK_{B} values in the context of the present invention are to be understood as meaning the pK_{B} values in “ideally dilute” aqueous solution, i.e. the pK_{B} values in the case of negligible interaction between the cation and the anion of the salt of the oxyacid, in the temperature range from 23° C. to 25° C. The following equation known for the corresponding acid-base pairs is applicable here with sufficient accuracy: pK_{A} +pK_{B}=14.00. Consequently, for example, the pK_{B} value of all hydroxides (irrespective of the counterion), for the purposes of the present invention, is equated to 0.00 and is therefore not within the inventive range from 0.1 to 7.0. The pK_{A} values of numerous oxyacids and hence also the pK_{B} values of their salts (via pK_{A}+pK_{B}=14.00) are known from the literature. Reference is especially made to the standard text “Holleman, Arnold F.; Wiberg, Egon; Wiberg, Nils: Lehrbuch der anorganischen Chemie, 101st edition, De Gruyter” which specifies numerous pK_{A} values of oxyacids in the chapters of the corresponding elements, for example: Orthophosphoric acid, pK_{A} of the third dissociation stage=12.3 (p. 771); orthosilicic acid, pK_{A} of the second dissociation stage=11.7 (p. 923) and “carbonic acid”, pK_{A} of the second dissociation stage=10.3 (p. 862).

If it is not possible to use literature values the pK_{B} value is determined in the context of the present invention by acid-base titration. This is effected by analytical determination of the base constant (K_{B}) of the anion of the oxyacid and calculation of the pK_{B} value. The procedure for such an acid-base titration is known to those skilled in the art. Reference is made to the relevant specialist literature “Gerhart Jander, Karl Friedrich Jahr, Gerhard Schulze, Jürgen Simon (Ed.): Maßanalyse. Theorie und Praxis der Titrationen mit chemischen und physikalischen Indikationen, 16th edition, Walter de Gruyter, Berlin 2003, page 67 to 128”. The base constants K_{B} are calculated using the equation for hydroxide ion concentration recited in the chapter “Sehr schwache Säuren und Basen” (pages 86 and 87). Solving this equation for K_{B} gives:

$${K}_{B} = [ {c}^{2} ( {OH}^{-} ) - {K}_{W} ] / {c}_{0} ( B ) , \qquad ( I )$$

where c(OH⁻) is the concentration of hydroxide ions determined by titration with an acid, KW is the ionic product of water (10⁻¹⁴ mol²/l²), and c₀(B) is the starting concentration of the base (= of the anion of the oxyacid), i.e. the concentration calculated from the starting weight. In many cases, especially in the lower region of the inventive pK_{B} range from 0.10 to 6.00, the influence of autoprotolysis of water is very small, and so it is also possible to perform the calculation using the simplified equation

$${K}_{B} = {c}^{2} ( {OH}^{-} ) / {c}_{0} ( B ) \qquad ( II )$$

though in case of doubt the exact equation (I) is decisive for the purposes of the invention. For the purposes of the present invention, the titration is conducted with 0.1 N hydrochloric acid using phenolphthalein.

According to the invention the at least one hydrolysis catalyst comprises a salt of an oxyacid of an element of the fifth, sixth, fourteenth or fifteenth group of the periodic table of the elements. The anion of the hydrolysis catalyst comprises, preferably consists of, at least one central metal, transition metal or non-metal atom which is coordinated by 3 or more oxygen atoms, at least one of which bears a negative formal charge. The central metal, transition metal or non-metal atom is preferably carbon, silicon, phosphorus, vanadium, molybdenum or tungsten. It is especially preferable when the anion is in the form of carbonate, silicate, silanolate, phosphate, phosphite, vanadate, molybdate and tungstate. It is particularly preferable when the salt of the oxyacid is an anion selected from
orthovanadate (VO₄³⁻),
carbonate (CO₃²⁻),
orthophosphate (PO₄³⁻),
diphosphate (P₂O₇⁴⁻),
triphosphate (P₃O₉⁵⁻),
tetraphosphate (P₄O₁₁⁶⁻),
metaphosphate ([PO₃)⁻]ₙ),
alkylphosphonate (RPO₃²⁻; where R is an alkyl radical having 1 to 18 carbon atoms, preferably 1 to 10 carbon atoms),
phosphite (HPO₄²⁻),
arylphosphonate (ArPO₃²⁻; where Ar is an aryl radical, especially phenyl),
hydrogenorthosilicate (HSiO₄³⁻),
metasilicate ([SiO₃²⁻]),
hydrogenmetasilicate ([HSiO₃⁻]ₙ),
dihydrogenorthosilicate (H₂SiO₄²⁻),
trihydrogenorthosilicate (H₃SiO₄⁻),
alkylsilanolate (RₓSiO₄₋ₓ^{(4-x)-}; where R is an alkyl radical having 1 to 18 carbon atoms, preferably 1 to 10 carbon atoms, and x is 1, 2 or 3 and preferably 1 or 2, particularly preferably 1) or
arylsilanolate (ArₓSiO₄₋ₓ^{(4-x)-}; where Ar describes an aryl radical, in particular phenyl, and x is 1, 2 or 3 and preferably 1 or 2, particularly preferably 1).
tungstate (WO₄²⁻),
polytungstate (W₄O₁₆⁸⁻; W₇O₂₄⁶⁻; W₁₀O₃₂⁴⁻; H₂W₁₂O₄₀⁶⁻; H₂W₁₂O₄₂¹⁰⁻),
molybdate (MoO₄²⁻),
polymolybdate (Mo₂O₇²⁻; MoO₂₄⁶⁻; Mo₈O₂₆⁴⁻; Mo₃₆O₁₁₂(H₂O)₁₆⁸⁻),

Particularly preferred anions among the aforementioned are WO₄²⁻, VO₄³⁻, CO₃²⁻, HPO₄²⁻, MoO₄²⁻, HSiO₄³⁻, RSiO₃³⁻, where R is an alkyl radical having 1 to 10 carbon atoms, or PO₄³⁻. Particularly preferred anions are PO₄³⁻.

It is likewise preferable to employ only one (1) salt of an oxyacid as catalyst and not a mixture.

It is further preferable when the reaction employs no further hydrolysis catalysts not recited above. It has proven advantageous to employ the salt of the oxyacid in amounts such that its mass is 0.10% to 20%, preferably 1.0% to 15%, particularly preferably 5.0% to 10%, of the mass of the carbonate, in particular polycarbonate, to be reacted.

According to the invention it is preferable when the cation of the salt is selected from an alkali metal ion, an alkaline earth metal ion and a quaternary ammonium ion. It is especially preferable when the salt is a sodium or potassium salt or a quaternary ammonium ion, particularly preferably a sodium or potassium salt. This preference applies especially in the case where the hydrolysis catalyst comprises the abovementioned preferred anions.

According to the invention the at least one phase-transfer catalyst comprises a charged organic molecule. It is particularly preferable when the at least one phase-transfer catalyst is a cationic surfactant. At least in this case the hydrolysis catalyst and the phase-transfer catalyst are clearly distinguishable through their chemical structure.

It is particularly preferable when the phase-transfer catalyst is elected from quaternary ammonium salts or quaternary phosphonium salts comprising organic radicals and a counterion. Particular preference is given to quaternary ammonium salts having organic radicals and a counterion. The organic radicals are preferably methyl, benzyl, butyl, octyl, hexadecyl or stearyl. The counterion is preferably chloride, bromide, sulfate, chlorate or triflate. The at least one phase-transfer catalyst is particularly preferably selected from the group consisting of trimethylbenzylammonium chloride, tetrabutylammonium chloride, dimethyldistearylammonium chloride, tetraphenylphosphonium chloride, hexadecyltributylphosphonium chloride and methyltrioctylphosphonium chloride and is very particularly preferably tetrabutylammonium chloride.

It will be appreciated that the phase-transfer catalyst too may have a certain activity as a hydrolysis catalyst (see above). The catalyst/catalysts may also be formed in situ. By way of example the following reaction could form a phase-transfer catalyst which then, however, as an anion simultaneously comprises the salt of an oxyacid of an element of the fifth, sixth, fourteenth or fifteenth group of the periodic table of elements and thus exhibits hydrolysis activity:

H₃PO₄+3R₄NOH→PO₄(R₄N)₃+3H₂O

Such embodiments are preferably encompassed according to the invention. In another embodiment the in situ formation of the catalysts is not encompassed.

It is likewise preferable to employ only one (1) phase-transfer catalyst and not a mixture. It is further preferable when the reaction employs no further phase-transfer catalysts not recited above.

It is preferable when the process according to the invention is characterized in that the phase-transfer catalyst is employed in a molar ratio to the hydrolysis catalyst of 0.5-1.5:1, particularly preferably of 0.75-1.25:1 and very particularly preferably of 1.1-1.3:1. It is especially preferable when the salt of the oxyacid is employed in a mass of 0.10% to 20%, preferably 1.0% to 15%, particularly preferably 5.0% to 10%, of the mass of the carbonate, in particular polycarbonate, to be reacted.

It is likewise preferable when the hydrolysis catalyst and/or the phase-transfer catalyst are employed in an amount of 0.005 to 0.15 molar equivalents based on 1 molar equivalent of carbonate.

It is particularly preferable to employ a mass ratio of (altogether employed) water to the carbonate, in particular polycarbonate, of 0.05:1.00 to 30.00:1.00, particularly preferably of 0.10:1.00 to 25.00:1.00.

The process according to the invention is preferably characterized in that the hydrolysis product obtained in step (ii) comprises at least one hydroxyl group. Depending on the reaction conditions the hydrolysis may also form other products. However, it is preferable when the hydrolysis product comprises at least one hydroxyl group. According to the invention this is to be understood as meaning that byproducts may still continue to be formed. However, the hydrolysis product having at least one hydroxyl group is the main product. A person skilled in the art is capable of optimizing the reaction conditions of the process according to the invention such that the yield and/or the purity of this main product is maximized. However, in this case the hydrolysis product may still contain small amounts of byproducts. It will likewise be appreciated that depending on whether a carbonate, biscarbonate etc. or a polycarbonate is hydrolysed the hydrolysis product may also comprise more than one hydroxyl group, in particular two hydroxyl groups.

The process according to the invention preferably further comprises the further step (iii) of:

(iii) separating the at least one hydrolysis product from at least the hydrolysis catalyst and the phase-transfer catalyst.

This step (iii) is especially intended to isolate and/or purify the obtained hydrolysis product. This then allows it to be sent to a further chemical reaction, in particular for synthesis of new materials intended for utilization such as a new polycarbonate. The hydrolysis product can also be separated from any residual water in step (iii). It has proven advantageous when the amount of organic solvent in process step (ii) is limited (see above). In this case process step (iii) may be performed particularly efficiently. This especially allows better separation of the aqueous phase with the phase-transfer catalyst and the hydrolysis catalyst from the hydrolysis product. Process step (iii) is preferably carried out by addition of water. This is to be understood as meaning that this water is actively added. It is thus preferably distinct from the water provided in process step (i). It is preferable when the phase-transfer catalyst and the electrolysis catalyst are dissolved in water (if the catalysts are identical only the one catalyst). The hydrolysis product is insoluble in water. This makes it possible to obtain a purer hydrolysis product in a manner known to those skilled in the art. The hydrolysis product may be subjected to further purification steps.

However, it is likewise possible to perform an extraction in process step (iii). The hydrolysis product is extracted with at least one organic solvent. Suitable organic solvents are aliphatic hydrocarbons, alicyclic hydrocarbons, aromatic hydrocarbons, halogen-substituted aliphatic hydrocarbons, halogen-substituted alicyclic hydrocarbons, halogen-substituted aromatic hydrocarbons and mixtures of two or more of the aforementioned organic solvents.

It will be appreciated by a person skilled in the art that the separation of the hydrolysis product from at least the hydrolysis catalyst and the phase-transfer catalyst need not necessarily proceed perfectly in the sense that all hydrolysis product is separated from all hydrolysis catalyst and/or all phase-transfer catalyst.

As mentioned above, the carbonate employed in the process according to the invention is especially preferably a polycarbonate. The polycarbonate may be an aliphatic or aromatic polycarbonate. The polycarbonate is preferably an aromatic polycarbonate. It is particularly preferably a polycarbonate produced on the basis of a bisphenol. It is further preferably a polycarbonate containing one or more monomer unit(s) of formula (4):

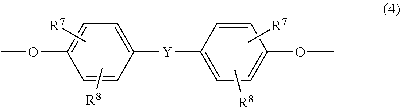

in which
R⁷ and R⁸ are independently of one another H, C₁-C₁₈-alkyl, C₁-C₁₈-alkoxy, halogen such as Cl or Br or respectively optionally substituted aryl or aralkyl, preferably H or C₁-C₁₂ alkyl, particularly preferably H or C₁-C₈-alkyl and very particularly preferably H or methyl, and
Y is a single bond, —SO₂—, —CO—, —O—, —S—, C₁-C₆-alkylene or C₂-C₅-alkylidene or else C₆-C₁₂-arylene which may optionally be fused to further heteroatom-containing aromatic rings.

The monomer unit(s) of general formula (4) are introduced into the polycarbonate or copolycarbonate via one or more corresponding diphenols of general formula (4a) in a manner known to those skilled in the art:

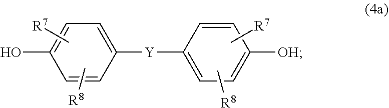

where R¹, R⁸ and Y are each as already defined in connection with formula (4).

Examples of the diphenols of formula (4a) include hydroquinone, resorcinol, dihydroxybiphenyls, bis(hydroxyphenyl)alkanes, bis(hydroxyphenyl)sulfides, bis(hydroxyphenyl)ethers, bis(hydroxyphenyl)ketones, bis(hydroxyphenyl)sulfones, bis(hydroxyphenyl)sulfoxides, alpha,alpha′-bis(hydroxyphenyl)diisopropylbenzenes and the ring-alkylated and ring-halogenated compounds thereof and also alpha,omega-bis(hydroxyphenyl)polysiloxanes.

It is very particularly preferable to employ compounds of general formula (4b),

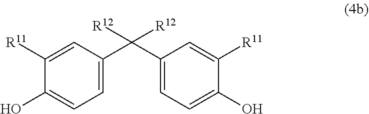

in which R¹¹ is H, linear or branched C₁-C₁₀-alkyl, preferably linear or branched C₁-C₆-alkyl, particularly preferably linear or branched C₁-C₄-alkyl, very particularly preferably H or C₁-alkyl (methyl) and
in which R¹² is linear or branched C₁-C₁₀-alkyl, preferably linear or branched C₁-C₆-alkyl, particularly preferably linear or branched C₁-C₄-alkyl, very particularly preferably C₁-alkyl (methyl).

Diphenol (4c) in particular is very particularly preferred here.

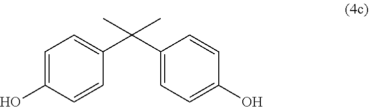 [SMILES: CC(C)(c1ccc(O)cc1)c1ccc(O)cc1]

The diphenols of the general formula (4a) may be used either alone or else in admixture with one another. The diphenols are known from the literature or producible by literature processes (see for example H. J. Buysch et al., Ullmann's Encyclopedia of Industrial Chemistry, VCH, New York 1991, 5th ed., vol. 19, p. 348).

If the polycarbonate is a copolycarbonate it is especially preferable when this copolycarbonate contains at least one unit of formula (1a), (1b), (1c), (1d) or any desired mixtures of formulae (1a), (1b), (1c) and (1d):

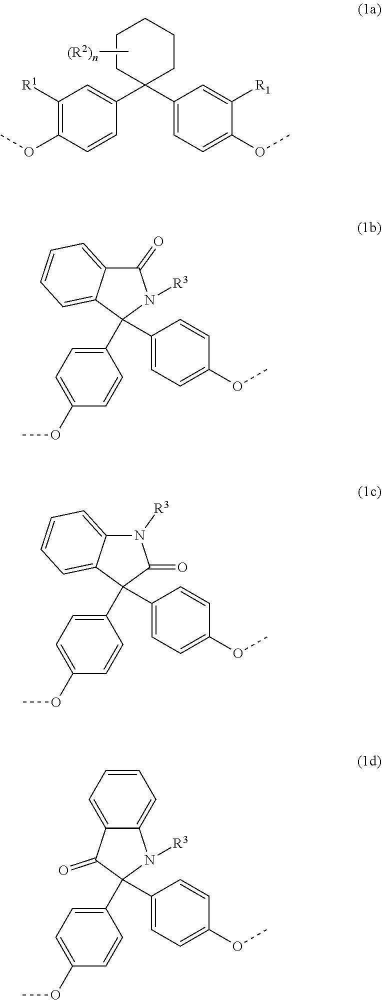

in which
R¹ is hydrogen or a C₁- to C₄-alkyl radical, preferably hydrogen,
R² is a C₁- to C₄-alkyl radical, preferably a methyl radical,
n is 0, 1, 2 or 3, preferably 3, and
R³ is a C₁- to C₄-alkyl radical, aralkyl radical or aryl radical, preferably a methyl radical or phenyl radical, most preferably a methyl radical.

It is especially preferable when the copolycarbonates additionally comprise units of the abovementioned formula (4).

In the case of copolycarbonates it is particularly preferable when they comprise at least one unit of formula (1a) in which R¹ represents hydrogen or a C₁- to C₄-alkyl radical, preferably hydrogen, R² is a C₁- to C₄-alkyl radical, preferably a methyl radical, and n is 0, 1, 2 or 3, preferably 3. It is particularly preferable when copolycarbonates comprise a unit of formula (1a) in which R¹ is hydrogen, R² is methyl and n is 3. Such a unit (1a) is derived from 1,1-bis(4-hydroxyphenyl)-3,3,5-trimethylcyclohexane (bisphenol TMC). Some of the diphenols of formula (1a) to be employed for producing the copolycarbonates are known in the literature (DE 3918406).

It is apparent to those skilled in the art that the hydrolysis product obtained according to the invention may comprise the abovementioned dihydroxy compounds, in particular bisphenols. The hydrolysis product obtained according to the invention is preferably represented by the formulae (4a), (4b) and (4c). It is likewise conceivable that the hydrolysis product is represented by the corresponding dihydroxy compounds of formulae (1a), (1b), (1c) or (1d).

It is apparent to those skilled in the art that when a copolycarbonate is concerned, different hydrolysis products may also correspondingly be obtained.

A further aspect of the present invention provides a process for producing polycarbonate comprising the steps of
(ia) performing the process for hydrolysis of polycarbonates according to the above-described process according to the invention optionally in a preferred form or in a combination of preferences (with the limitation that the carbonate is a polycarbonate) at least to obtain a dihydroxy compound as hydrolysis product and
(iia) separating the dihydroxy compound as hydrolysis product from step (ia) from at least the hydrolysis catalyst and the phase-transfer catalyst and
(iiia) reacting the dihydroxy compound as separated hydrolysis product of step (iia) with phosgene in the phase interface process or
(iiib) reacting the dihydroxy compound as separated hydrolysis product of step (iia) with a diaryl carbonate in the melt transesterification process.

This process makes it possible to initially convert especially already utilized polycarbonate such as post-consumer polycarbonate back into its building blocks and then use the obtained hydrolysis products to produce new polycarbonate.

In this case process step (iia) is a preferred mode of performing process step (iii) which has already been described in detail and in preferred embodiments above.

In particular, further workup of the obtained hydrolysis product may be carried out after process step (iia). This workup shall effect purification of the hydrolysis product in order to be able to use this in process step (iiia) or (iiib). Especially a recrystallization of the hydrolysis product in a manner known to those skilled in the art is possible for example.

Performance of process step (iiia) is known to those skilled in the art. For example in the phase interface process the hydrolysis products such as for example bisphenols and any branching agents may be dissolved in an aqueous alkaline solution and reacted with the phosgene optionally dissolved in a solvent in a biphasic mixture of an aqueous alkaline solution, an organic solvent and a catalyst, preferably an amine compound. The reaction may also be carried out in a multi-step mode. Such processes for producing polycarbonate are in principle known as two-phase interface processes, for example from H. Schnell, Chemistry and Physics of Polycarbonates, Polymer Reviews, vol. 9, Interscience Publishers, New York 1964 p. 33 ff. and from Polymer Reviews, vol. 10, “Condensation Polymers by Interfacial and Solution Methods”, Paul W. Morgan, Interscience Publishers, New York 1965, chapter VIII, p. 325, and the essential conditions are therefore familiar to those skilled in the art.

Alternatively, process step (iiib) is likewise known to those skilled in the art. The melt transesterification process is described for example in the Encyclopedia of Polymer Science, vol. 10 (1969), Chemistry and Physics of Polycarbonates, Polymer Reviews, H. Schnell, vol. 9, John Wiley and Sons, Inc. (1964) and in DE-C 10 31 512. In the melt transesterification process the hydrolysis products such as for example bisphenols are transesterified in the melt with diaryl carbonates using suitable catalysts and optionally other additives.

### EXAMPLES

### Hydrolysis of Polycarbonate (PC) to Afford Bisphenol A (BPA)

51 mg of cryomilled polycarbonate (PC, 0.19 mmol, having an Mn of 46 500 g/mol (GPC, BHT); originally 3 mm granulate, 1.00 eq.) or 0.19 mmol of DiCPC was initially charged in a pressure tube having a volume of 9 ml. The hydrolysis catalyst (0.1 eq.) specified in the table and optionally tetrabutylammonium chloride (Bu₄NCl*H₂O) (0.1 eq.) as phase-transfer catalyst were subsequently added. Finally, 1 ml of dist. water was added to the mixture. The vessel was sealed and heated for 17 h with stirring. The mixture was mixed with a few millilitres of tetrahydrofuran (THF) to dissolve the reaction products. The resulting conversion was determined by proton magnetic resonance spectroscopy (¹H-NMR) in dimethyl sulfoxide-d6 as solvent. The signal group from 7.31-7.22 ppm of the PC was integrated as a reference for monitoring conversion.

¹H-NMR (400 MHz, DMSO-d₆): δ 6.99-6.88 (m, 4H, BPA), 6.66-6.57 (m, 4H, BPA), 3.59 (tq, J=5.9, 1.7 Hz, THF), 3.54 (s, H₂O), 2.50 (p, DMSO), 1.75 (td, J=5.9, 5.0, 2.5 Hz, THF), 1.50 (s, 6H, BPA).

The results are summarized in table 1:

TABLE 1

| | | Phase- | | | | |
|---|---|---|---|---|---|---|
| | | transfer | | | | |
| | Hydrolysis catalyst | catalyst | Reaction time | Temperature | Conversion^{a} | |
| Substrate | (charge) | (charge) | [h] | [° C.] | [%] | Ex |
| DiCPC | Na₂WO₄ (10 mol %) | — | 17 | 100 | Traces | comp. |
| DiCPC | Na₂WO₄ (10 mol %) | — | 168 | 100 | Traces | comp. |
| DiCPC | Na₂WO₄ (10 mol %) | Bu₄NCl | 17 | 110 | 100^{c} | inv. |
| | | (10 mol %) | | | | |
| DiCPC | Rb₂CO₃ (10 mol %) | Bu₄NCl | 17 | 110 | 100^{c} | inv. |
| | | (10 mol %) | | | | |
| DiCPC | Cs₂CO₃ (10 mol %) | Bu₄NCl | 17 | 110 | 100^{c} | inv. |
| | | (10 mol %) | | | | |
| DiCPC | Li₂CO₃ (10 mol %) | Bu₄NCl | 17 | 110 | 100^{c} | inv. |
| | | (10 mol %) | | | | |
| DiCPC | — | Bu₄NCl | 17 | 110 | 5 | comp. |
| | | (10 mol %) | | | | |
| PC | — | Bu₄NCl | 17 | 110 | 0 | comp. |
| | | (10 mol %) | | | | |
| PC | NaCl | — | 17 | 110 | 0 | comp. |
| PC | Na₂WO₄ (10 mol %) | Bu₄NCl | 17 | 110 | >95 | inv. |
| | | (10 mol %) | | | | |
| PC | Na₃VO₄(10 mol %) | Bu₄NCl | 17 | 110 | >95 | inv. |
| | | (10 mol %) | | | | |
| PC | K₂CO₃ (10 mol %) | Bu₄NCl | 17 | 110 | >95 | inv. |
| | | (10 mol %) | | | | |
| PC | K₃PO₄(10 mol %) | Bu₄NCl | 17 | 110 | >95 | inv. |
| | | (10 mol %) | | | | |
| PC | Na₂MoO₄ (10 mol %) | Bu₄NCl | 17 | 110 | >95 | inv. |
| | | (10 mol %) | | | | |
| PC | Na₂CO₃ (10 mol %) | Bu₄NCl | 17 | 110 | >95 | inv. |
| | | (10 mol %) | | | | |
| PC | Na₃PO₄ (10 mol %) | Bu₄NCl | 17 | 110 | >95 | inv. |
| | | (10 mol %) | | | | |
| PC | (NaOH)ₓ (NaSiO₃)_{y}* | Bu₄NCl | 17 | 110 | 100 | inv. |
| | z H₂O | (10 mol %) | | | | |
| PC | [K₃(n-butyl)(SiO₃)] | Bu₄NCl | 17 | 110 | 97 | inv. |
| | (10 mol %) | (10 mol %) | | | | |

PC: polycarbonate; DiCPC: bis(p-cumyl)carbonate.

As is apparent from the table the hydrolysis of DiCPC and also of polycarbonate is unsuccessful without the presence of a phase-transfer catalyst.

1. A process for hydrolysis of carbonates, comprising the steps of;
(i) providing a carbonate, at least one hydrolysis catalyst and water, wherein the at least one hydrolysis catalyst comprises a salt of an oxyacid of an element of the fifth, sixth, fourteenth or fifteenth group of the periodic table of the elements, wherein the pK_{B} value of the anion of the salt is in the range from 0.1 to 7.0; and
(ii) performing the hydrolysis by contacting the components from step (i) to obtain at least one hydrolysis product and carbon dioxide,
wherein in step (ii) at least one phase-transfer catalyst is present, wherein the at least one phase-transfer catalyst comprises a charged organic molecule.

2. The process according to claim 1, wherein the hydrolysis product obtained in step (ii) comprises at least one hydroxyl group.

3. The process according to claim 2, further comprising step (iii) of
(iii) separating the at least one hydrolysis product from at least the hydrolysis catalyst and the phase-transfer catalyst.

4. The process according to claim 1, wherein process step (ii) is performed at a temperature of 50° C. to 180° C.

5. The process according to claim 1, wherein at least one alcohol is present in the hydrolysis of process step (ii).

6. The process according to claim 1, wherein at most 15% of the mass of the water present in process step (ii) is an organic solvent.

7. The process according to claim 14, wherein the anion of the salt comprises WO₄²⁻, VO₄³⁻, CO₃²⁻, HPO₄²⁻, MoO₄²⁻, HSiO₄³⁻, RSiO₃³⁻, where R is an alkyl radical having 1 to 10 carbon atoms, or PO₄³⁻.

8. The process according to claim 1, wherein the cation of the salt is selected from an alkali metal ion and an alkaline earth metal ion.

9. The process according to claim 8, wherein the salt is a sodium or potassium salt.

10. The process according to claim 1, wherein the at least one phase-transfer catalyst is a cationic surfactant.

11. The process according to claim 10, wherein the at least one phase-transfer catalyst is selected from the group consisting of trimethylbenzylammonium chloride, tetrabutylammonium chloride, dimethyldistearylammonium chloride, tetraphenylphosphonium chloride, hexadecyltributylphosphonium chloride and methyltrioctylphosphonium chloride.

12. The process according to claim 5, wherein the salt of the oxyacid is employed in a mass fraction of 0.10% to 20% based on a total mass of the carbonate.

13. The process according to claim 1, wherein the carbonate is a polycarbonate.

14. The process according to claim 13, wherein the polycarbonate is aromatic.

15. A process for producing polycarbonate comprising the steps of
(ia) performing the process for hydrolysis according to claim 13 for polycarbonates at least to obtain a dihydroxy compound as hydrolysis product;
(iia) separating the dihydroxy compound as hydrolysis product from step (ia) from at least the hydrolysis catalyst and the phase-transfer catalyst; and
(iiia) reacting the dihydroxy compound as separated hydrolysis product of step (iia) with phosgene in the phase interface process or
(iiib) reacting the dihydroxy compound as separated hydrolysis product of step (iia) with a diaryl carbonate in the melt transesterification process.

16. The process according to claim 4, wherein process step (ii) is performed under reflux or in a closed system.

17. The process according to claim 12, wherein the salt of the oxyacid is employed in a mass fraction of 5.0% to 10% based on the total mass of the carbonate.

18. The process according to claim 12, wherein the carbonate is polycarbonate.
